(19) United States
(12) Patent Application Publication
(10) Pub. No.: US 2012/0046964 A1
(43) Pub. Date: Feb. 23, 2012

(54) METHOD OF COORDINATING PROFESSIONAL SERVICES

(76) Inventor: Angelo A. Papa, New Castle, PA (US)

(21) Appl. No.: 13/225,501

(22) Filed: Sep. 5, 2011

Related U.S. Application Data
(63) Continuation-in-part of application No. 11/928,316, filed on Oct. 30, 2007.

(51) Int. Cl. G06Q 50/22; G06Q 50/16; G06Q 40/08; G06Q 50/18; G06Q 10/00; G06Q 40/06

(52) U.S. Cl. 705/2; 705/1.1; 705/35; 705/4; 705/311; 705/313

(57) ABSTRACT

A method of doing business is practiced by a group of independent professionals to meet the varied but related needs of an individual. The method uses a centralized computer system to coordinate professional services to an individual. Professional entities, such as attorneys, physicians, pharmacists, realtors, architects, financial institutions and advisors, insurance agents, bondsman, psychologists, enter into a coalition agreement. The coalition agreement defines a standard infrastructure comprising documentation, modes of communication, and administrative case management, all of which are operable and accessible through the centralized computer system. The professional entities form facilitator groups directed to particular multi-disciplinary problems, which individuals face. The standard infrastructure coordinates the activities of the professional entities. Individuals benefit by having a coordinated approach to their problems and convenience of an apparent single provider through a single user interface.

The present invention is a continuation-in-part of U.S. Ser. No. 11/928,316 and claims priority to U.S. 60/855,879, both of which are hereby incorporated by reference.

### FIELD OF THE INVENTION

The invention relates to a method of doing business using computer hardware and software, more particularly relating to a method of coordinating diverse professional services to patients, clients, or customers.

### BACKGROUND OF THE INVENTION

Individuals often need the coordinated services of trained professionals, such as attorneys, physicians, psychologists, pharmacists, accountants, bankers, and realtors. These services are typically isolated so that professionals are unaware of an individual's complete situation, visa vie, legal, medical, or financial. A single professional is likely to consider only the particular needs of the individual in that professional's particular sphere of influence. This limited sphere of influence may, for example, cause an attorney to recommend an inappropriate or harmful legal course of action because of conflicts with the individual's medical needs or financial abilities.

While isolated advice is often sufficient, some situations require a more integrated approach. Such situations arise when an individual has, for example, overlapping legal, medical or psychological needs. In one situation, an individual, who has been arrested for a drug related offense, will require legal services but may also require medical, psychological, and pharmacological services to combat a drug habit. Further, drug addiction may also have decimated the individual's finances to the point that financial services are necessary.

Professionals have attempted to cooperate for the good of the individual. Such cooperation has remained little more than a post facto exchange of business cards. Coordination of services on behalf of the individual has been difficult and limited.

A need exists for a multi-disciplinary approach to individual needs. Professionals must remain independent yet cooperate for the good of the individual. Preferably, the professionals could share standardized forms and communicate for problem solving in a secure networked environment.

### SUMMARY OF THE INVENTION

The invention describes a method of doing business comprising a system. The system can include, for example, a computer and other computer hardware. The computer may include a server. The method enables users, whether professionals or clients, to connect remotely to the system via the Internet. Users can access the system through user interfaces (UIs). The UIs can be designed to allow access to various modules that permit communication, treatment and management of a client's individual needs. The method also allows doctors, psychologists, lawyers, and other professionals to coordinate a client's treatment at any time.

### DESCRIPTION OF THE INVENTION

The invention describes a method of doing business that is practiced by a group of independent professionals to meet the varied but related needs of an individual. The method includes a secure networked computerized system that can steer individuals through the various resources related to their specific circumstance. The description anticipates that the invention may be used in other applications and may be implemented in other embodiments.

The method of doing business includes creating a coalition of professional entities divided into one or more facilitator groups. Professional entities may include, for example, attorneys, physicians, pharmacists, realtors, architects, financial institutions and advisors, insurance agents, bondsman, psychologists, and any other person possessing a needed skill. Each facilitator group comprises a plurality of professional entities. A facilitator group is created to meet the likely needs of an individual in a particular circumstance, such as drug-addicted persons, estate and retirement planning, or real estate. The facilitator group includes at least two professional entities. Professional entities may belong to more than one facilitator group.

Importantly, the coalition agrees to work together in a coordinated approach within a particular infrastructure. Infrastructure includes a system for supporting documentation, modes of communication, and administrative case management. The system comprises a computer and necessary peripherals such as, for example, host servers, hubs and switches that enable remote access by users across the Internet most commonly through a web site. The system manages access of documents, communication, and case management, and permits remote access to professionals and clients. Given the confidential nature of client data, the system will be a secure networked environment.

Documents include forms, contracts, marketing pieces, instructional pieces, and administrative pieces. Preferably, documents are completed electronically while linked to the system. A standard format permits individuals to fill out a single form that is shared, as need and as authorized by the individual, so that paperwork is reduced while privacy is maintained. Similarly, standard contracts, shared marketing, individual instruction, and centralized administration ease the burden on both professional entities and individuals. The modes of communication include a standard mode so that the individual receives all pertinent information in the same standard manner and in the same standard format. Conveniently, the client may access this information remotely via an individualized user interface (UI) on the system. This improves understanding by and compliance from individuals. Conveniently, the system enables centralization administration of case management so that individuals may contact a single location with all responses, appointments, deadlines, fee collection, fee projection, etc. Appointments with multiple professionals may be scheduled with a single call or visit to the UI. The common infrastructure coordinates the activities of professional entities that belong to the coalition. Communication within the infrastructure permits group communications, and is particularly useful when the schedules of individuals or professional entities are not synchronous. Infrastructure communication can preferably maintain an audit trail of communications, permit persons to add to the communication, complete documentation, validate research, and allow group conferencing.

Infrastructure may be collected, stored and disseminated on the system using present technology, such as electronic transmittal of forms, scanned hardcopies, spreadsheets, database management, and calendaring and scheduling programs. Future technological developments are expected to simplify documentation, communication and administration. Documents may be disseminated to the facilitator group through the system, preferably via electronic media. Conveniently, the system permits communication to be forwarded from a centralized switchboard using, for example, a computer server, VOIP or other telecommunications device. Alternatively, communication may include virtual conferencing or teleconferencing. Preferably, communication will process through the system to facilitate docketing, recording, transmission, and billing of the communication. Such communication can render the physical location of the professional entity largely irrelevant. In this manner, facilitator groups comprising professional entities from several localities, states and even nations may be formed. Administration includes managing the individual's case, including appointment tracking, medical procedures, court dates, closing dates, and related events. Central administration through the system enables monitoring of client progress, and can also monitor quality control of the various professionals.

The coalition may collect an association fee from professional entities. The fee may cover expenses, such as advertising, marketing, and infrastructure. Fee schedules will depend on the type, quality and quantity of service provided. The fee may depend on actual services provided by the coalition, such as marketing, advertising, billing or administration services. Alternatively, the fee could include, if permitted, a percentage of professional fees charged by the entity as a member of a facilitator group. Professionals could even be charged based on their usage of the system. In order to reach prospective clients, the coalition will preferably advertises its services via all forms of direct-to-consumer advertising including print, broadcast and internet media. The advertisement invites inquiries, such as by a toll free telephone number to the central administration system, from interested persons.

The goal of the coalition at this early stage is to offer a one-stop solution for prospective clients. The coalition may field questions about a problem and gain the confidence of the prospective clients, thereby steering clients to an appropriate associated professional entity of the coalition. The appropriate entity will have familiarity with the client's problem. Using the system, the coalition may even make an appointment for the prospective client with the suitable professional entity, and may follow-up with a reminder to the prospective client to attend the appointment, as well as a follow-up to determine whether the appointment was completed. Once the prospective client meets with the professional entity, the entity may form a suitable facilitator group with other professional entities. These professional entities will preferably be members of the coalition.

The professional entities first identify a particular problem that is likely to be faced by individuals. The entities may then establish at least one facilitator group directed to the problem. Alternatively, the entities may form a facilitator group once a suitable individual is identified. Professional entities may create and belong to more than one facilitator group. The professional entities or, if already formed, members of a facilitator group will seek to identify individuals, who suffer from the problem and could benefit from the integrated approach of the facilitator group.

The coalition preferably has an arrangement with a number of different professional entities with applicable skill sets so that their expertise may be made available to prospective clients for a particular problem. Each professional entity should agree in principal to accept a specified prospective client. Acceptance may depend on professional ethics, a personal meeting with the prospective client, or other suitable criteria. If permitted, the professional entity may pay a referral fee to the coalition. The coalition may use all or part of this fee for marketing, advertising, or simply as a finder's fee.

Professional entities can use the business method to improve the level of care they provide to their clients. The method uses a computer system to fill a void in multi-disciplinary legal cases in which doctors, lawyers, counselors, treatment specialists and the addicts can work together securely and confidentially. A centralized system that documents all of a client's needs permits professionals to improve the level of care they provide to the client. Conveniently, the method can be used in estate planning, criminal defense, combating drug addiction, and real estate.

An estate planning facilitator group may include an estate lawyer, an accountant, insurance salesman and tax lawyer. Real property facilitator groups may include realtors, property lawyers, financial institutions, title insurance companies, architects, labor and industry consultants, and labor and industry lawyers. Criminal defendants with drug addiction may require a facilitator group having lawyers, bondsman, psychologists, medical doctors, pharmacists, and lifestyle counselors. The business method comprising the computer system described above is particularly effective at marketing, recruiting, communicating, documenting, scheduling and managing such groups.

An embodiment of the invention includes assisting drug-addicted individuals using a five-step process, including orientation, assessment, intervention, and wellness planning. The method can also generate a validation if required by a court of law. Orientation can include the use of the system, a portable laptop, and a web camera. Assessment can be performed, at least in part, using a custom UI on the system. Optionally, assessment can also include a portable laptop and web camera. Based on data collected by the system in the orientation and assessment stages, professionals share the results that were collected and placed in the system's database. Collectively, the professionals can then create an intervention for the individual as well as a wellness plan. Further, the system can generate for each individual a validation for the court system.

Orientation includes collecting information relating to the individual and the individual's specific needs. The information is preferably transferred to the computer system so that the appropriate professionals can access and share data. Orientation includes a formal written agreement between the coalition and the individual. The agreement can include responsibilities of the individual including fees, rules, and possible sanctions to be imposed by the coalition on the individual. The agreement can also include portions relating to professional representation; behavioral modification; powers of attorney and other like legal documents; HIPPA and other information waivers; supplemental bond or sentence conditions, last chance employment, expulsion, or licensing agreements; court orders including custody order; or combinations thereof. These documents should be available to the professionals and the individual via the system. Orientation can include communication relating to infrastructure and library services of the coalition.

Assessment includes assignment of the individual to a standing or ad hoc facilitator group. The facilitator group includes a plurality of professional entities having the necessary expertise. For example, a facilitator group for an individual arrested for driving under the influence can include medical, legal, counseling, financial, and insurance professionals.

Intervention includes a treatment plan based on findings from the assessment. Intervention can include a pharmacological treatment plan, a treatment by a physician and/or counselor, legal and financial recommendations, or combinations thereof. Recommendations can include in-patient or out-patient treatment, environmental changes including “safe house” relocation, rehabilitation, video depositions or live testimony, or combinations thereof.

The wellness plan includes a comprehensive plan including the mental, physical, spiritual, and social health of the individual. The plan includes a menu of approved activities, local agencies, and nonprofit organizations, such as for example, local public libraries; local colleges and universities; web-based assets; governmental publications; local YMCA's; health spas; martial arts studios; local clergy, local ministries, religious publications, media and assemblies; vocational support, including local career link, retraining, vocational-technical opportunities, résumé services, placement services; and leadership, and citizenship programs.

Validation includes compliance enforcement using, for example, urinalysis, hair drug testing, biological monitoring reports, physician assessments, probation reports, and monitoring of activities via global positioning system.

### Example 1

A facilitator group was formed for the benefit of drug-addicted individuals with legal problems. The group comprised a mentor, lawyer, physician, counselor, and pharmacist. A five step approach was identified for treatment of such individuals, including (1) orientation, (2) assessment, (3) physician pharmacological intervention, (4) total wellness plan, and (5) validation.

Stage 1 included orientation of the individual to the coalition structure and practices. A member of the facilitator group met with the individual for a free consultation of at least one hour. The individual consented to the standardized rules, regulations, restrictions, sanctions, goals, and general objectives of the program. All information from the individual was processed into the coalition administration library, and the individual's information was made available to group members. Examples of such information include the professional representation contract, behavioral modification contract, powers of attorney and other like legal documents, HIPAA and other information waivers

Stage 2 included assessment by professional entities to determine the individual's needs, specifically pertaining to his substance abuse, psychological state, legal situation. A course of treatment was determined from the standardized assessment forms and evaluated for findings and recommendations. The physician determined an individualized, prescribed, treatment strategy plan, and transmitted this plan through the coalition infrastructure. The plan was incorporated into the information from stage 1. Ultimately, the plan was fully incorporated into the final, long-term stage 5 comprehensive plan, and the plan was written into court documents relating to sentence conditions. Plans may also be written into bond agreements, last chance employment contracts, last chance student expulsion contracts, last chance professional licensure contracts, custody orders, protection from abuse orders, and civil domestic orders.

Stage 3 included setting up an appointment for the individual with a treating physician through the coalition infrastructure. The physician assigned a treatment strategy, which included but would not be limited to, medication to implement pharmacological intervention for detoxification and other pharmacology for a drug/alcohol-free maintenance program. The physician's recommendations included a coalition drug-free safe house and referral to a coalition in-house rehabilitation. The individual consented in writing to all recommendations. Written consent was filed in the coalition's library.

Stage 4 included establishing a total wellness plan that re-incorporated the individual into society. The individual was aligned with local agencies that were able to assist the individual in following the prescribed plan. Stage 5 included a validation/compliance plan. The plan was incorporated into court records concerning the individual's probation report.

### Example 2

The individual is assessed using the system, that is, the computer or server, normally via a remote laptop with a web camera and transmission link. This personalized assessment is used in coalition with assessment forms and evaluated for findings, recommendations, and implementations of strategies concerning psychological, substance abuse, and civil and criminal legal issues. A coalition physician schedules a coalition priority appointment with the individual and, after assessment, the physician may assign a treatment strategy. The treatment strategy can become part of a comprehensive plan embracing health of the individual including mental, physical, spiritual, and social health. The strategy may include but is not limited to, prescriptive or other medication to implement pharmacological intervention for detoxification. The physician may also prescribe other pharmacology for a drug/alcohol-free maintenance or treatment program. Recommendations may include a short-term coalition safe house or other environmental changes, such as referral to a coalition outsourced in-house rehabilitation. In addition to any other, immediate, short, intermediate, or long-range objectives, including but not limited to coalition 5-step process, all recommendations will be memorialized and written into the individual's plan maintained in the coalition library on the system.

The comprehensive plan is enacted with emphasis upon the “total” human being, that is, mental, physical, and spiritual dimensions. Immediate, short, intermediate, and long-term assessments lead to strategies and implementation of defined activities, which may involve coalition providers. Activities include local agencies, nonprofit organizations, local public library, local colleges and universities, web-based assets, governmental publications, local YMCA's, health spas, martial arts; local clergy, local ministries, religious publications, media, assemblies; vocational support, retraining, vocational-technical opportunities, résumé services, placement services, educational, leadership, citizenship programs, and socialization.

Finally, the coalition prepares a report for written or oral presentation containing, the history of the individual's success. The presentation may be incorporated into treatment strategies added to sentence conditions, last chance employment contracts, professional licensures, expulsions, custody hearings, behavioral modification, and various memberships. The coalition may certify to third parties the individual's compliance with the treatment program through the use of drug screening, urinalysis, hair drug tests, biological monitoring reports, GPS records, attendance, and community service reports, diplomas, certificates, and in formal pre-sentence report.

In performing the services, the coalition may depend on the following infrastructure including a centralized administration using the remote user's computer to establish a telecommunications link to the network web site wherein the network web site comprises; (i) a central host server coupled to a communications network for accessing the systems user interfaces (UIs) followed by the remote user having access to the specifically designed programs upon request by the remote user and (ii) a central storage device for storing the different forms and products that allow full communication, treatment and management of each client's individual needs. Beyond this dedicated infrastructure, the coalition my also depend on web-based administration, scheduling, and communication, conference telephone line, instant messaging, internet forums, standardized forms, as well as public service seminars and presentation.

Numerous modifications and variations of the present invention are possible. It is, therefore, to be understood that within the scope of the following claims, the invention may be practiced otherwise than as specifically described. While this invention has been described with respect to certain preferred embodiments, different variations, modifications, and additions to the invention will become evident to persons of ordinary skill in the art. All such modifications, variations, and additions are intended to be encompassed within the scope of this patent, which is limited only by the claims appended hereto.

1. A method of doing business comprising:
a) assembling a coalition comprising a plurality of professional entities bound by a common infrastructure centrally administered through system comprising a computer;
b) forming a facilitator group from the coalition to address a problem of an individual, where the facilitator group includes at least two of the professional entities; and
c) directing the individual to contact the common infrastructure for an issue related to the problem.

2. The method of claim 1, wherein the plurality of professional entities are selected from a group consisting of an attorney, physician, pharmacist, realtor, architect, financial institution, financial advisor, insurance agent, bondsman, psychologist, and combinations thereof.

3. The method of claim 1, wherein the common infrastructure includes documentation, a mode of communication, and an administrative case management, and the system stores computer programs, treatment programs, assessments, documentation, and client information.

4. The method of claim 3, wherein the documentation is selected from a group consisting of a form, contract, marketing piece, instructional piece, administrative piece, and combinations thereof, and the documentation is collected and stored in the system.

5. The method of claim 3, wherein the mode of communication includes electronic transmittal of information using remote access through a secure networked environment.

6. The method of claim 5, wherein the electronic transmittal of information is selected from a group consisting of electronic forms, scanned hardcopies, spreadsheets, database management, calendaring programs, scheduling programs, telecommunications, virtual conferencing, and combinations thereof.

7. The method of claim 3, wherein administration case management is selected from a group consisting of appointment scheduling, docketing of legal deadlines, billing, fee collection, fee projection, communication with the individual, individual progress notes, or combinations thereof.

8. (canceled)

9. The method of claim 1, further comprising communicating with the individual in a standard mode comprising a standard manner and a standard format.

10. (canceled)

11. The method of claim 1, further comprising the coalition collecting a fee from the plurality of professional entities.

12. The method of claim 11, wherein the fee is assessed based on services selected from a group consisting of advertising, marketing, licensing, billing, administrative, infrastructure, and combinations thereof.

13. The method of claim 11, wherein the fee is a percentage of professional fees charged by professional entities of the coalition.

14. A method of doing business including:
a) assembling a coalition comprising a plurality of professional entities bound by a common infrastructure centrally administered through system comprising a computer;
b) identifying an individual with a problem; and
c) establishing a treatment plan for the individual including a plurality of steps including an orientation, an assessment, an intervention, a wellness plan, and a validation.

15. The method of claim 14, wherein the orientation includes collecting information about the individual and forming an agreement between the individual and the coalition.

16. The method of claim 14, wherein the assessment includes assignment of the individual to a facilitator group comprising at least two of the professional entities.

17. The method of claim 14, wherein the intervention is selected from a group consisting of a pharmacological treatment plan, a treatment by a physician, a treatment by a counselor, a legal recommendation, financial recommendation, in-patient treatment, out-patient treatment, environmental changes, rehabilitation, video depositions, live testimony, or combinations thereof.

18. The method of claim 14, wherein the wellness plan includes a comprehensive plan embracing health of the individual including mental, physical, spiritual, and social health; the comprehensive plan including a menu of approved activities, organizations, individuals, and combinations thereof.

19. The method of claim 14, wherein the validation includes compliance enforcement selected from a group consisting of urinalysis, hair drug testing, biological monitoring reports, physician assessments, probation reports, and monitoring of activities via global positioning system.

20. A method of doing business comprising:
a) assembling a coalition comprising a plurality of professional entities bound by a common infrastructure centrally administered through system comprising a computer;
b) forming a facilitator group from the coalition to address a problem of an individual, where the facilitator group includes at least two professional entities;
c) establishing a treatment plan for the individual including a plurality of steps including an orientation, an assessment, an intervention, a wellness plan, and a validation;
d) directing the individual to contact the centralized administration for any issues related to the problem;
e) communicating with the individual in a standard mode comprising a standard manner and a standard format; and
f) collecting a fee by the coalition from professional entities of the facilitator group.

21. The method of claim 1, further comprising:
a) Permitting remote contact of the common infrastructure by the individual using an Internet web site;
b) transmitting user identification data from an individual's remote computer to the computer of the common infrastructure;
c) identifying and tracking the individual through the web site.

22. The method of claim 1, wherein the computer comprises a central host server coupled to a communications network that permits remote access to the system by a user.

23. The method of claim 22, further comprising the central host server presenting a remote user with an individualized user interface.

24. The method of claim 23, wherein the individualized user interface permits access to a portion of the common infrastructure.

25. The method of claim 23, wherein the portion of the common infrastructure includes modules relating to an individual's communication, treatment and management.
